(19) United States
(12) Patent Application Publication
(10) Pub. No.: US 2019/0012688 A1
(43) Pub. Date: Jan. 10, 2019

(54) AUTOMATED COMPARABLE-BASED PRICING USING NON-ZERO-DIFFERENCE COMPARABLES

(71) Applicant: BROKER GENIUS, INC., Far Rockaway, NY (US)

(72) Inventors: Shmuel Sherman, Valley Stream, NY (US); Jim McGowan, Flemington, NJ (US)

(21) Appl. No.: 16/031,907

(22) Filed: Jul. 10, 2018

Related U.S. Application Data
(60) Provisional application No. 62/530,834, filed on Jul. 10, 2017.
(60) Provisional application No. 62/530,831, filed on Jul. 10, 2017.
(60) Provisional application No. 62/530,833, filed on Jul. 10, 2017.
(60) Provisional application No. 62/530,836, filed on Jul. 10, 2017.

(51) Int. Cl. G06Q 30/02; G06F 17/30

(52) U.S. Cl. CPC G06Q 30/0206; G06Q 30/0283; G06F 17/30241

(57) ABSTRACT

A method for evaluating price functions for access credentials, the system comprising: accessing, using a processor having memory and configured by cod, a venue map from a venue map database; receiving a data value corresponding to an uncategorized access credential for an event occurring within the venue, obtaining, from an access credential database, a dataset of access credentials for purchase, where each access credential for purchase includes at least one data feature having a common characteristic with the uncategorized access credential; determining a market value for each of the access credentials within the dataset; adjusting at least one pricing data value of the uncharacterized access credential in response to the determined market value for each access credential in the dataset; accessing, from a pricing function database, a pricing function for the uncharacterized access credential; wherein the pricing function receives as at least one input the price of access credentials within the access credential dataset; and updating the at least one pricing data value of the uncharacterized access credential in response to the output of the pricing function.

### CROSS REFERENCE TO RELATED APPLICATIONS

This Application claims priority to U.S. Application No. 62/530,834, filed on Jul. 10, 2017 and herein incorporates by reference the same. This application claims priority to U.S. Application No. 62/530,831, filed on Jul. 10, 2017 and herein incorporates by reference the same. This application claims priority to U.S. Application No. 62/530,833, filed on Jul. 10, 2017 and herein incorporates by reference the same. This application claims priority to U.S. Application No. 62/530,836, filed on Jul. 10, 2017 and herein incorporates by reference the same. Each of the foregoing Applications are incorporated by reference as if presented in their entirety.

### BACKGROUND OF THE INVENTION

Access credential, such as tickets, can be sold on a primary market. The primary market is the event vendor selling tickets directly to consumers. However, tickets can also be sold on a secondary market, where ticket brokers purchase tickets from the primary event vendor and sell them on a secondary marketplace. The secondary market of the event ticket industry has a dynamic, and often chaotic, pricing structure. Tickets are listed for sale under various pricing arrangements, in which brokers who own the vast majority of inventory are assigning prices in an attempt to maximize return on their investment.

In the art, a popular approach to pricing inventory on the secondary market is to use a pricing strategy called a “comp based” method. Here, tickets are assigned a price based upon the price of available, comparable inventory. For instance, if a broker is pricing a pair of tickets in row 1 or another desirable section of a venue, the broker may choose to assign a price slightly lower than another pair of tickets available in the same row and section, but from a different broker. When a consumer attempts to purchase the tickets, she will see the two listings with comparable seats and often will choose the lower priced inventory.

Such competitive pricing can result in price spirals eroding the profit margins of tickets. However, more importantly, such pricing spirals can become hi-speed events that require a broker to have constant information and updates regarding sales prices, availability and other data. Thus, what is needed in the art are one or more computer implemented solutions that permit a broker to have optimal access to one or more graphical user interfaces that provide given functionality for a given circumstance. More importantly, what is needed is a dynamic graphical display of information where portions of the display are updated in real time in response to changes in a dynamic market for inventory.

### SUMMARY OF THE INVENTION

The systems, methods and described herein are directed to automated comp-based pricing solutions, and dynamic displays that enable the generation thereof. For example, the automated pricing involves accessing through one or more computer networks a listing which is available for sale. As used herein, a listing is a group of one or more tickets sold in a single transaction. From this listing, specific entries are selected that are anticipated to sell at comparable value. In one or more implementations, such selection is conducted automatically. Alternatively, the selection of entries is done manually by a user.

In a further implementation, a computer system suitably configured selects the desired listing entries automatically, based on the location of the seat within the stadium, and number of tickets in the listing. For instance, comparable seats may be those in the same row in the same section, surrounding sections, a few surrounding rows, and sections on the opposite side of the venue (e.g., 50 yard line seats on the east are comparable to 50 yard line seats on the west).

The user or automatic computer system then establishes a pricing rule according to the market prices of those listings, such as “price $1 cheaper than the cheapest listing”. In practice rules may be more complicated, but the methodology is the same.

It will be appreciated that manual comp-based pricing follows the same logical steps as those described herein. However, the automated pricing described in the present application allows to advance the technical art by applying the rule repeatedly against a real-time list of market data as the prices of the comparables change. This benefit becomes more pronounced when such automatic pricing is done so without the intervention of a user, and at a rate and volume exceeding that possible by even the most diligent manual pricer.

Implicit in the above procedure is that the comparable listings must be equivalent, or equal, in value to the listing. No existing method of automated comp-based pricing allows one to price relative to a more or less expensive listing, accounting for the expected offset in price. For instance, there is no automated method for implementing the following: “Price $10 cheaper than a 20% reduction in cost from the seat 3 rows ahead, and $5 cheaper than a 10% increase in cost from the seat 12 rows behind”. In such cases, the broker is not attempting to simply price competitively against the market of similarly priced tickets, but it trying to divine the cost function and decision-making process applied by a consumer when assessing which of two different listings to purchase. A consumer may assess the situation such as “I would pay more for the seat three rows close, but not that much more. I would certainly pay a little more for the seat much closer than the one 12 rows behind”. Clearly this is a more complex situation, since the seller cannot really price according to the double rule above unless by chance, the price relative to the seat ahead and the seat behind, as stated, were equal. To simplify, when comparing to two tickets priced at $100 each, a consumer cannot be both $1 cheaper than one ($99), and simultaneously $1 more expensive than the other ($101). Accordingly, a single price must be calculated that optimizes the seller's stance against comparables of varying prices and relative perceived values, as estimated by the seller.

This becomes critical as the existence of comparable listings is sparse, which occurs as inventory has sold off, or when a broker owns a substantial number of listings in an area of a venue. In such cases, equal based comps may not be available. A consumer is no longer choosing the best value among a set of near-equal value listings, but is applying something more complex in making a purchasing decision.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram illustrating particular elements according to one embodiment of the present invention.

FIG. 2 is a flow diagram illustrating particular steps according to one embodiment of the present invention.

FIG. 3 presents a collection of modules detailing the operative functions of the access credential management system according to one configuration of the present invention.

FIG. 4 presents a graphical user interface details one or more operative functions of the access credential management system according to one configuration of the present invention.

### DETAILED DESCRIPTION OF CERTAIN EMBODIMENTS OF THE INVENTION

This application is herein incorporates by reference: U.S. patent application Ser. No. [TBD] and titled “Default Venue Maps” filed concurrently herewith and having attorney docket number 10153/006063-US1; U.S. patent application Ser. No. [TBD] and titled “System and Apparatus for the Display and Selection of Listings and Splits” filed concurrently herewith and having attorney docket number 10153/006064-US1; U.S. patent application Ser. No. [TBD] and titled “Various Methods For Displaying Venue Information On A Venue Map” filed concurrently herewith and having attorney docket number 10153/006066-US1. Each of the foregoing Applications are incorporated by reference as if presented in their entirety.

By way of overview and introduction, various embodiments of the systems and methods described herein are directed a computer system configured to implement a non-zero difference comparable pricing mechanism.

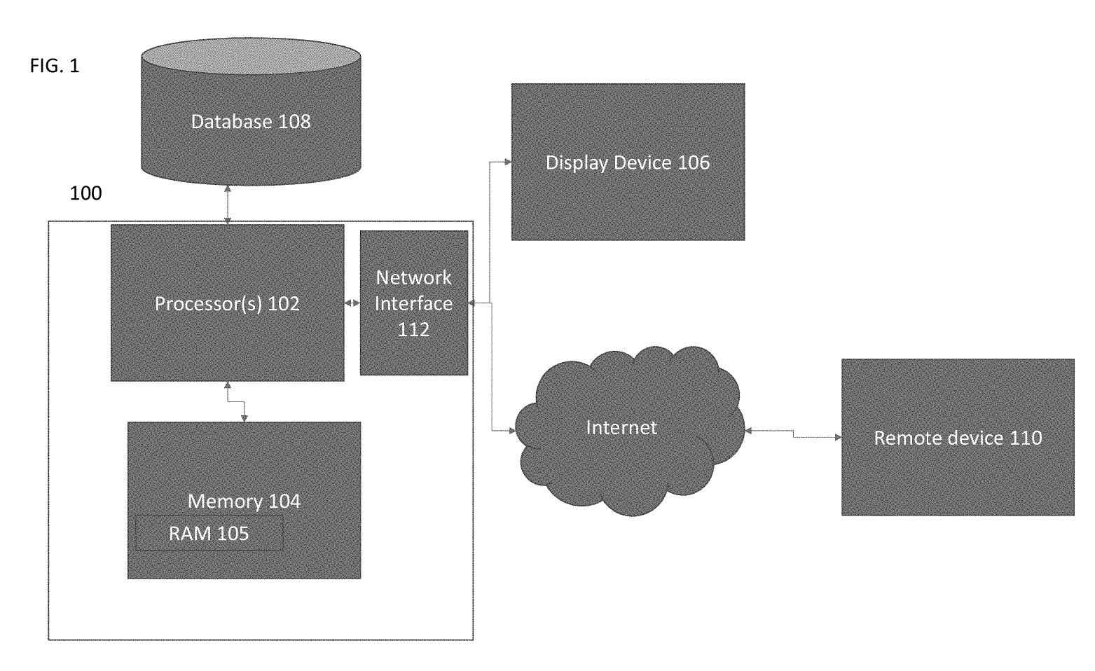

Turning now to FIG. 1, a computer system 100 is provided to access, evaluate and transform data. In one or more configurations, the computer system 100 is composed of one (1) or more processors 102 configured to execute code residing therein. For instance, in one implementation, the computer system is a standard computing device such as, but not limited to, commercially available computing device. For example, the processor 102 may be a collection of computers, servers, processors, cloud-based computing elements, micro-computing elements, computer-on-chip(s), home entertainment consoles, media players, set-top boxes, prototyping devices or “hobby” computing elements.

Furthermore, the processor 102 can comprise a single processor, multiple discrete processors, a multi-core processor, or other type of processor(s) known to those of skill in the art, depending on the particular embodiment. In a particular example, the processor 102 executes software code on the hardware of a custom or commercially available cellphone, smartphone, notebook, workstation or desktop computer configured to receive data either directly from one or more memories or data storage devices, or indirectly through a communication linkage to one or more memories or data storage devices, such as database 108.

The processor 102 is configured to execute a commercially available or custom operating system, e.g., MICROSOFT WINDOWS, APPLE OSX, UNIX or Linux based operating system in order to carry out instructions or code.

In one or more implementations, the processor 102 is further configured to access various peripheral devices and network interfaces. For instance, the processor 104 is configured to communicate over the internet with one or more remote servers, computers, peripherals or other hardware using standard or custom communication protocols and settings (e.g., TCP/IP, etc.).

The processor 102 may include one or more memory storage devices (memories). The memory is a persistent or non-persistent storage device (such as an IC memory element) that is operative to store the operating system in addition to one or more software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules. In one or more embodiments, the memory of the processor 102 provides for the storage of application program and data files. One or more memories provide program code that the processor 102 reads and executes upon receipt of a start, or initiation signal.

The computer memories may also comprise secondary computer memory, such as magnetic or optical disk drives or flash memory, that provide long term storage of data in a manner similar to a persistent memory device. In one or more embodiments, the memory of the processor 102 provides for storage of an application program and data files when needed.

In one implementation, each element provided in FIG. 1 is configured to communicate with one another through one or more direct connections, such as though a common bus. Alternatively, each element is configured to communicate with the others through network connections or interfaces, such as a local area network LAN or data cable connection. In an alternative implementation, the display device 106, remote computer 110, processor 102, and database 108 are each connected to a network, such as the internet, and are configured to communicate and exchange data using commonly known and understood communication protocols.

In a particular implementation, the processor 102 is a computer, workstation, thin client or portable computing device such as an Apple iPad/iPhone® or Android® device or other commercially available mobile electronic device configured to receive and output data to or from database 108, display device 106 and/or remote computer device 110. Here, the processor 102 communicates with a display device 110 for displaying data as well as input hardware to permit a user to access information, and to send commands and/or instructions to the processor 102 and the color measurement device. In one or more implementations, the display device 106 is a screen, monitor, display, LED, LCD or OLED panel, augmented or virtual reality interface or an electronic ink-based display device.

Those possessing an ordinary level of skill in the requisite art will appreciate that additional features, such as power supplies, power sources, power management circuitry, control interfaces, relays, interfaces, and/or other elements used to supply power and interconnect electronic components and control activations are appreciated and understood to be incorporated.

As shown, memory 104 and persistent storage 108 are examples of computer-readable tangible storage devices. A storage device is any piece of hardware that is capable of storing information, such as, data, program code in functional form, and/or other suitable information on a temporary basis and/or permanent basis. In one or more embodiments, memory 104 includes random access memory (RAM) 105. RAM 105 may be used to store data such as the venue data in accordance with the present invention. In general, memory 104 can include any suitable volatile or non-volatile computer-readable storage device. Software and data are stored in persistent storage 108 for access and/or execution by processors 102 via one or more memories of memory 104. With respect to remote device 110, for example, software and data are stored locally on the remote computing system.

In a particular embodiment, persistent storage 108 includes a magnetic hard disk drive. Alternatively, or in addition to a magnetic hard disk drive, persistent storage 108 can include a solid state hard drive, a semiconductor storage device, read-only memory (ROM), erasable programmable read-only memory (EPROM), flash memory, or any other computer-readable storage devices capable of storing program instructions or digital information.

The database 108 may be embodied as solid-state memory (e.g., ROM), hard disk drive systems, RAID, disk arrays, storage area networks (“SAN”), network attached storage (“NAS”) and/or any other suitable system for storing computer data. In addition, the database 108 may comprise caches, including database caches and/or web caches. Programmatically, the database 108 may comprise flat-file data store, a relational database, an object-oriented database, a hybrid relational-object database, a key-value data store such as HADOOP or MONGODB, in addition to other systems for the structure and retrieval of data that are well known to those of skill in the art.

The media used by persistent storage 108 may also be removable. For example, a removable hard drive may be used for persistent storage 108. Other examples include optical and magnetic disks, thumb drives, and smart cards that are inserted into a drive for transfer onto another computer-readable storage medium that is also part of persistent storage 108.

Communications or network interface unit 112, in these examples, provides for communications with other sub-systems or devices. In an embodiment, communications unit 112 may provide appropriate interfaces to the Internet or other suitable data communications network to connect to one or more servers, resources, API hosts, or computers. In these examples, communications unit 112 may include one or more network interface cards. Communications unit 112 may provide communications through the use of either or both physical and wireless communications links.

Display 106 provides a mechanism to display data to a user and may be, for example, a computer monitor. Display 106 can also function as a touch screen, such as a display of a tablet computer.

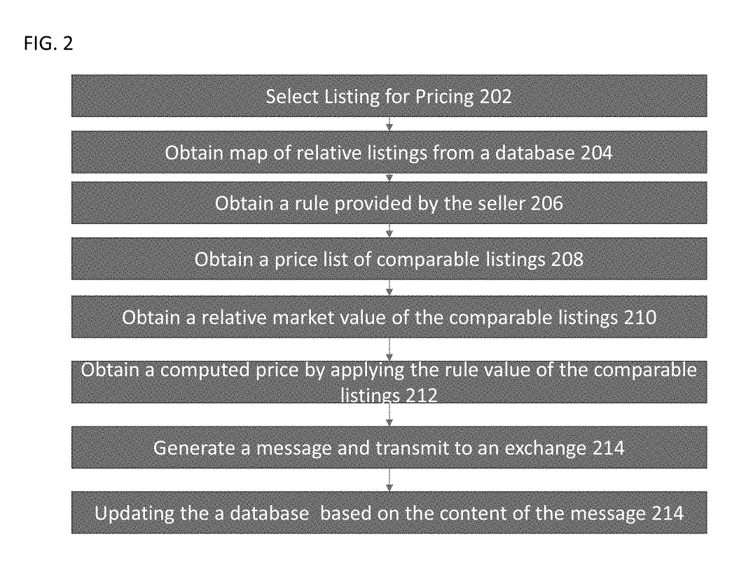

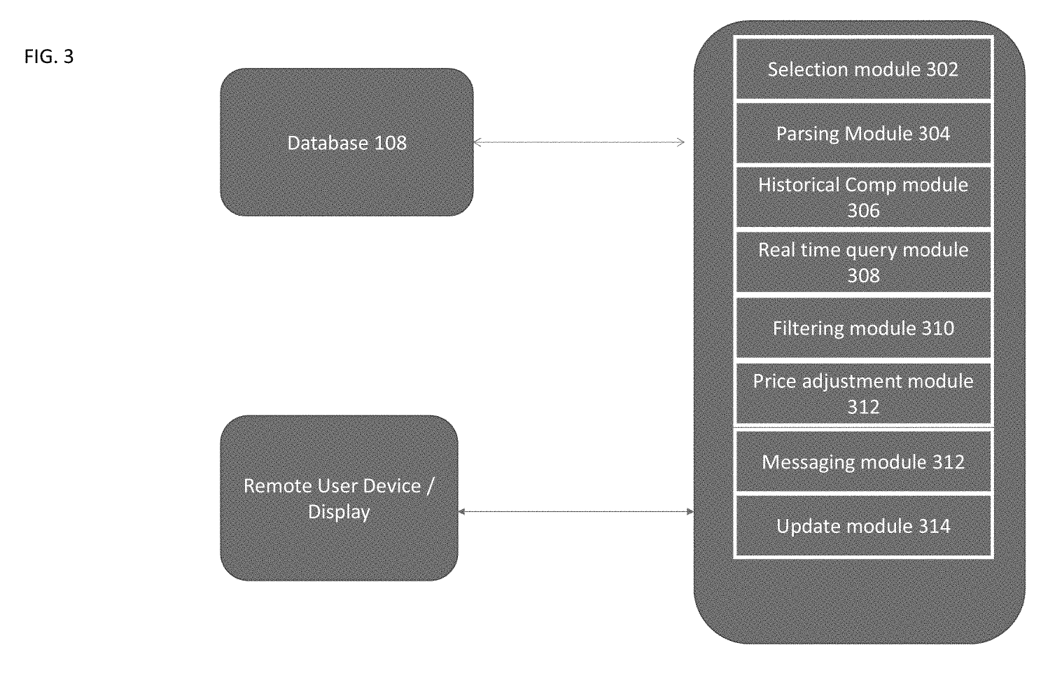

Returning to the systems and methods described herein, the computer system is configured by one or more software modules executed as code by the processor(s) 102 to implement steps 202-218 as provided in FIG. 2. In one or more configurations, the steps are implemented as code modules, as provided in FIG. 3.

In one or more configurations, a user (such as a user of the remote computing device or display device) selects a listing for pricing from a display of listings. For example, the processor 102 is configured to provide to the display device a graphical user interface that lists a user's inventory. Here, the user's inventory is obtained from the database 108. However, in alternative configurations, the user's inventory data is obtained through one or more access requests to a third-party data store or data provider.

In step 202, a listing is selected for pricing. Here, a user interacts with the graphical user interface presented on the display device or on the display of a remote computing device 110. For example, the user selects an access credential from a list of access credentials to being pricing. In one implementation, the selection is effectuated by clicking, touching or otherwise registering an input.

In another implementation, the processor 102 is configured by a selection module 301 to initiate the pricing step. Here, upon receipt of one or more user selections; data representing selection of access credentials to a system capable of such pricing, data received from an Application Programming Interface (API) or similar interface, the processor 102 is configured to evaluate the data for pricing. For example, a user of the remote device 110 is able to exchange data with the computer 102 to effectuate the selection of a listing stored within database 108.

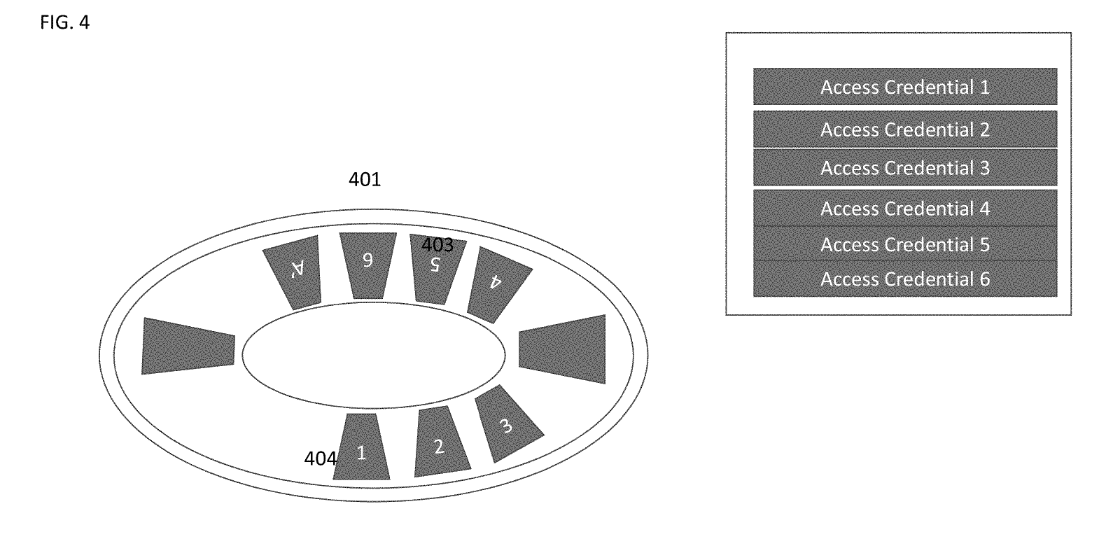

As shown in step 204, a virtual map of relative listing values is obtained from a database 108. For example, the processor 102 is configured by the map accesses module 302 to access a virtual map. Here, the map access module 302 includes a collection of one or more submodules that configure the processor 102 to access a local or remote storage location, query a remote resource with the desired venue information, formatting and or other additional operating functions. For example, in one or more configurations, a venue map for a given venue event is accessed from a remote web host or server and is received as a data stream, file, binary string, JSON object, vector data, image data or another data format. Upon receipt by the processor 102, the event venue map (such as map 401 of FIG. 4) can be displayed on the display device 106 or stored in temporary or working memory for further processing. In yet a further configuration, the venue map(s) received by the processor 102 include at least real-time inventory data. In a further arrangement, the venue data also includes historical data, a plurality of unique seats or locations within the venue, GIS data, elevation data, cross-linked or directly linked image data. Venue data in real-time, is presented to a user on a user interface displayed by the display device or remote device.

In one or more implementations, the map access module 302 also configures the processor 102 to access from one or more datastores or databases, a collection of access credential data associates with a given event at the venue represented by the venue map. For instance, the processor 102 is further configured by query of the entries of a database area submodule of the map access module to generate a query of a access credential database for all access credentials offered for sale for a given event at a given venue. However, in one or more implementations, the relative listing of access credentials represents not only presently available access credentials, but access credentials previously sold for the same or similar event at the same or similar venue. In yet a further implementation, the relative access credential listing represents the results of a search or query based, inter alia, on historical sales data, the opinion of a seller or expert pricer, or a custom template (e.g. a query) created by the seller or his agent. The list may contain the present and or past sales of access credentials for an entire venue, or some subsection of the venue relevant to the listing obtained in step 202.

In the turning to step 206, a rule provided by the seller is obtained by a suitably configured processor 102 from a database 108 or other memory. For example, the processor 102 is configured by a rule access module 304 to access a rule stored in one or more data stores. In one implementation, the rule accessed by the processor 102 is a rule unique or custom to the user. In an alternative configuration, the rule is selected from a list of pre-defined or pre-determined rules. In one configuration, the user initiates a request for a given or stored rule. Here, the rule is obtained by a user selecting a rule from a user interface such as incorporated into the display device 106 or remote device 110. In a further implementation, the rule is obtained from a default template, which may be tuned to the seller's preferences using one or more user data objects stored in the database 108, the remote device 110 or the memory 104. In one or more configurations, the rule is stored in the working memory of the processor for further use.

In one or more implementations, the rule accessed by the processor 102 is a data object, data file, instruction set, logic flow or other source of information or data that configures or instructs the processor to evaluate pricing data obtained by the processor 102.

As shown with respect to step 208, the price a collection of comparable listing data is obtained by a suitably configured processor 102 from a market data source. For instance, the processor 102 is configured by the market data access module 306 to access comparable access credential market from one or more remote data sources. For example, the remote data source is a data stream accessible by the processor 102 through an API. Alternatively, the market data source is a collection of entries stored database 108 or in one or more additional databases (not shown). Where the market data source is stored in an additional database, the database may be owned by a third party, and may be made available through an API. For instance, the one or more additional databases are owned by a ticket exchange (a piece of software designed to exchange tickets between sellers and buyers) and made available through a web-connection, interface or API.

Turning now to step 210, a suitably configured processor 102 obtains or generates a value that corresponds to the Relative Market Value (RMV) of the listing by applying a utility function to the market values. In one particular implementation, the processor 102 is configured by a market value calculation module 308 to compute the relative market value. In one or more specific implementations, a suitably configured processor 102 generates the Relative Market Value (RMV) as an assessment of the value of a listing taking into account comparable listings across a set of listings.

By way or overview, the relative values of particular unique locations (e.g. seats) can be expressed, inter alia, relative to a base value. For instance, a seat (403 of FIG. 4) furthest back in a venue region may be assigned a relative value of 1.0. Here, a region refers to a subsection of the venue, or the entirety of the venue. By way of illustrative, non-limiting example, where the region has 40 rows, all seats in rows 31 through 40 may receive the same value of 1.0. Seats in rows 11 through 20 may receive a value of 1.2. Seats in rows 5-10 may receive 1.5, and seats in rows 1-4 may receive 2.0. The aisle seats in row 1 (e.g. 404) may receive a 2.5. This, in one particular implementation, the value assigned to each access credential is a function of the relative distance of a given access credential from a base access credential location. In one particular arrangement, the closer a given access credential is to a pre-determined landmark, the higher the given value of an access credential will be.

In a particular implementation, a processor 102 configured by the market value calculation module 308 generates the Relative Market Value (RMV) by (a) multiplying the relative value of each seat by the market value for each seat, (b) averaging those values over all seats, and (c) multiplying that value by the weight for the given seat.

As another non-limiting example, consider a specific user or agent is trying to determine how to price a seat with a weight of 2.0, against market data. On the market, a seat weighted at 1.5 is available for $30, and one weighted at 2.5 is available for $45. The value assigned at this stage is 2.0*(($30/1.5)+($45/2.5))/2=$38. The Relative Market Value of the seat itself then is $38.

The Raw Relative Market Value of a listing may be calculated by simply summing all seats in the listing. In this example, if four identically valued seats were being priced (which is often the case), the Raw Relative Market Value of the listing would be $38*4=$152.

In a further implementation, the weight or other value is adjusted by include one or more adjustments based on the relative value of listing as a function of the rarity of the listing size. For instance, a listing of four tickets may receive a higher value than the sum of the four tickets comprising the listing if four ticket listings are relatively rare, and market demand is relatively high. In this case, the $152 value may be below the potential market value, and the processor 102 is configured to adjust the price in response to the rarity, demand, and other factors. For instance, this weight might be determined by taking the ratio of the expected RMV for each listing of 4 tickets to the actual RMV for listings of 4 in the market. If 3 other listings were computed at $100, $100 and $200, yet were listed on the market as $120, $120 and $240, the ratio would be ($100+$100+$200)/($120+$120+$240)=1.2. Such a calculation is referred to as the Split Ratio.

In one particular implementation, the processor 102 is configured to generate a absolute or definitive RMV. For example, the processor 102 is configured by the market calculation module 308 to determine the market price by obtaining the value corresponding to the Raw RMV times the Split Ratio. In this case, it would be $152*1.2=$182.40. Therefore, the value computed in this example would be $182.40, and the seller's pricing rule would be applied to that in step 6.

As shown with respect to step 212, a processor 102 generates a Computed Price (CP) for a given listing by applying the rule obtained in the step 206 to the Relative Market Value. For example, where the given listing has a price that is not in compliance with the rule provided in step 206, the processor 102 configured by a price adjustment module 310, alters the price to a new computed price for the listing.

Turning to step 214, a suitably configured processor 102 generates a message based on the computed price and sends the message to an exchange. In one implementation, the processor 102 is configured by a messaging module 312 to generate and send a message directly, via an API (Application Programming interface), to a point of sale or other system to effectuate an updated price listing. In an alternative configuration, the suitably configured processor 102 connects to the exchange though a different interface. In a further implementation, the suitably configured processor 102 updates one or more listing databases connected to a particular point of sale (POS) system used by the ticket exchanges. Here, the processor 102 is configured by the messaging module 312 to update the pricing data either through the POS database or an API, which in turn causes a database in the exchange to be updated.

In yet a further step 216, the suitably configured processor 102 accesses a timing routine or temporal data object to determine when to reengage the pricing data. For example, as the expiration date or event data for a particular listing approaches, the processor 102 is configured by an update module to access an update rule, market data, and to generate new pricing values based on the updated RMV and CP values. Thus, as the time to the event decreased, the processor 102 is configured to increase the update frequency of the steps provided herein starting with step 208.

In a further arrangement, the suitably configured processor 102 is configured to constantly monitor or evaluate present or historical price information or market data for the comparable listings. In a further implementation, one or more submodules of the update module 314 configures the processor to obtain a time series of data stored in the working memory of the suitably configured processor 102. Here, the suitably configured processor 102 evaluates the rate of change of comparable ticket prices. Where the rate of change in pricing of the comparable market data (e.g. ticket prices) is greater than the update frequency or rate of the suitably configured processor 102, then the suitably configured processor 102 changes the frequency of the update procedure to match or exceed the current price changing rate.

It should be noted that the order of some steps is arbitrary, and given for demonstration purposes only. For instance, the various items may be obtained in arbitrary order.

It should be understood by someone with ordinary skill in the art that these specific computations are for demonstrative purposes only, and that the exact algorithm used in the computation may vary based on many factors.

Those possessing an ordinary level of skill in the requisite art will appreciate that the where the present invention is a system, a method, and/or a computer program product, the he computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Haskell, R, Clojure, javascript, C#, Swift, Lua, Pearl, Python, Ruby, or the like, and conventional procedural programming languages, such as the “C” programming language, object-oriented programming languages, functional programming languages or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The block diagrams in the illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGs.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments may be utilized in many different types of data processing environments. In order to provide a context for the description of the specific elements and functionality of the illustrative embodiments, are provided hereafter as example environments in which aspects of the illustrative embodiments may be implemented. It should be appreciated that are only examples and are not intended to assert or imply any limitation with regard to the environments in which aspects or embodiments of the present invention may be implemented. Many modifications to the depicted environments may be made without departing from the spirit and scope of the present invention.

While this specification contains many specific embodiment details, these should not be construed as limitations on the scope of any embodiment or of what can be claimed, but rather as descriptions of features that can be specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying FIGs. do not necessarily require the particular order shown, or sequential order, to achieve desirable results. In certain embodiments, multitasking and parallel processing can be advantageous.

Publications and references to known registered marks representing various systems are cited throughout this application, the disclosures of which are incorporated herein by reference. Citation of any above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the claims that follow, the respective features recited in those points, and by equivalents of such features.

What is claimed is:

1. A system for evaluating price functions for access credentials, the system comprising:
A first database of access credentials, where the first database contains a listing of access credentials for purchase;
a second database of pricing functions;
a processor, having a memory and configured by code executing therein to:
access a venue map from a venue map database;
receive a data value corresponding to a uncategorized access credential for an event occurring within the venue,
obtain from the first database a dataset of access credentials for purchase, where each access credential for purchase includes at least one data feature having a common characteristic with the uncategorized access credential;
determine a relative market value for each of the access credentials within the dataset;
adjust at least one pricing data value of the uncharacterized access credential in response to the determined market value for each access credential in the dataset;
access, from the second database, a pricing function for the uncharacterized access credential; wherein the pricing function receives as at least one input the price of access credentials within the access credential dataset; and
using the pricing function adjust the at least one pricing data value;

2. The system of claim 2, wherein the processor is further configured to generate a message that includes the corresponding adjusted pricing data value.

3. The system of claim 3, wherein the processor is configured to receive from a remote computing device acknowledgement of receipt of the message, and update the database of access credentials with the adjusted price.

4. The system of claim 1, where the processor is configured to calculate the relative market value by assigning each of the access credentials within the dataset a base value as a function of distance from a given landmark within the virtual map.

5. The system of claim 4, wherein the processor is further configured to calculate the relative market value by (a) multiplying the base value of each seat by the market value for each seat, (b) averaging those values over all access credentials, and (c) multiplying the calculated value by the weight for the given access credential.

6. A method for evaluating price functions for access credentials, the system comprising:
accessing, using a processor having memory and configured by code, a venue map from a venue map database;
receiving a data value corresponding to an uncategorized access credential for an event occurring within the venue,
obtaining, from an access credential database, a dataset of access credentials for purchase, where each access credential for purchase includes at least one data feature having a common characteristic with the uncategorized access credential;
determining a market value for each of the access credentials within the dataset;
adjusting at least one pricing data value of the uncharacterized access credential in response to the determined market value for each access credential in the dataset;
accessing, from a pricing function database, a pricing function for the uncharacterized access credential; wherein the pricing function receives as at least one input the price of access credentials within the access credential dataset; and
updating the at least one pricing data value of the uncharacterized access credential in response to the output of the pricing function.

7. The method of claim 6, further comprising generating a message that includes the corresponding adjusted pricing data value.

8. The method of claim 7, comprising receiving from a remote computing device acknowledgement of receipt of the message, and updating the database of access credentials with the adjusted price.

9. The method of claim 6, wherein calculating the relative market value includes: assigning each of the access credentials within the dataset a base value as a function of distance from a given landmark within the virtual map.

10. The system of claim 9, wherein calculating the relative market value by (a) multiplying the base value of each seat by the market value for each seat, (b) averaging those values over all access credentials, and (c) multiplying the calculated value by the weight for the given access credential.
